(19) United States
(12) Patent Application Publication
(10) Pub. No.: US 2022/0318757 A1
(43) Pub. Date: Oct. 6, 2022

(54) SYSTEM FOR VERIFYING EDUCATION AND EMPLOYMENT OF A CANDIDATE VIA A BLOCKCHAIN NETWORK

(71) Applicants: Zain Zaidi, Newark, CA (US); Emaan Zaidi, Newark, CA (US); Ali Zaheer, Whitby (CA); Najaf Hashim, Fremont, CA (US); Masooma Batool, Whitby (CA); Taufiq Saleem, Newark, CA (US)

(72) Inventors: Zain Zaidi, Newark, CA (US); Emaan Zaidi, Newark, CA (US); Ali Zaheer, Whitby (CA); Najaf Hashim, Fremont, CA (US); Masooma Batool, Whitby (CA); Taufiq Saleem, Newark, CA (US)

(73) Assignee: Transcrypt Solutions Inc., Newark, CA (US)

(21) Appl. No.: 17/220,930

(22) Filed: Apr. 2, 2021

(51) Int. Cl. G06Q 10/10; G06Q 50/20; G06K 19/06; G06F 21/45

(52) U.S. Cl. CPC G06Q 10/1053; G06Q 50/2053; G06K 19/06037; G06F 21/45; G06Q 2220/00; G06F 9/45533

(57) ABSTRACT

A system for verifying and issuing the credentials of a candidate using blockchain technology is disclosed. The system is configured to enable candidates to store blockchain credentials and verify the candidates' blockchain credentials and create a blockchain based credential wallet for the users and/or candidates to securely transfer/share the credentials. The system enables issuers to check, verify, and also transfer or share diplomas and certificates, test results, and professional accreditation to the user's blockchain based credential wallet via the network. The system enables receivers to verify the blockchain credentials of a candidate from the blockchain based credential wallet via the network. The system enables the users to share the blockchain credentials and apply universities and jobs using the blockchain credentials stored in the blockchain based credential wallet, and also enables the candidates to share the blockchain credentials to one or more third parties through a quick response (QR) code/URL link/HyperLink.

### BACKGROUND OF THE INVENTION

### A. Technical Field

The present invention generally relates to a system for verifying the education and employment of candidates. More specifically, the present invention relates to a system for verifying blockchain credentials of candidates via a blockchain network and creating a blockchain-based credentials wallet for users and/or candidates to securely transfer/share credentials to universities, human resources, companies, organizations, institutions, and third parties, etc. The system is further configured to automatically sync with existing databases and/or any organizations, institutions, on-premise, cloud, and decentralized databases for retrieving data and using that retrieved data to issue blockchain credentials periodically to the users.

### B. Description of Related Art

Blockchain is a distributed ledger that makes sharing information more secure and transparent. At its core, a blockchain is a ledger through which data is added and updated in real-time via consensus of the different nodes running the software in the network. Blockchain could be described as an open distributed ledger that can record transactions between two parties efficiently and in a verifiable and permanent way. Blockchain technology enables users to construct a shared, distributed, and fault-tolerant database and also removes the need for a third party to verify the legitimacy and integrity of the data. As such, blockchain technology will have a widespread and fundamental impact on almost every single industry, particularly in education and employment verification. Currently, there are many mechanisms that companies and hiring managers could leverage to check the credentials, education history, employment history, and background checks of prospective candidates before making hiring decisions. In a typical process, background checks are performed after an offer is extended to a candidate. Several categories of background checks may be performed including identity checks, credit history checks, criminal background checks, and education and employment experience checks.

The current process for verifying a candidate's credentials such as their education and employment could be very time-consuming, redundant, and expensive. In a typical case, companies have to go through many steps to complete the education and employment experience background check for a prospective employee. These steps may include, but are not limited to, receiving an application; conducting an initial screening; judging the candidate on additional qualification metrics; making an offer; conducting internal verification; conducting additional verifications through third-party agencies; and repeating these steps for any background mismatches that may be uncovered in the process. This process could take up to two or three weeks if not longer, to complete for an individual hire. Not only is this process inefficient, and financially costly, but it could also increase the chances of losing the best candidates to competitor companies based on the time delay.

Further, the current process of verifying educational transcripts and other education credentials is slow, redundant, costly, and non-transparent. To prevent tampering, users have to request their high schools or universities to directly send their documents to the educational institute or employment they are applying to. This process is redundant because it must be performed for each application to an educational institute and/or workplace. It is costly because schools usually charge a fee to send these documents. It is not transparent because by directly sending the documents between the institute and receiving institute the user is unable to view the documents being sent, and can never be sure of the exact documents that were sent or the contents of the documents.

As an employer trying to verify a prospective employee's previous record, it leaves open opportunities for fraud. A person applying for a job might give fraudulent contacts as references, which might falsely identify themselves as points of contact at the previous work experience.

In addition, data sharing or transferring between companies, institutions such as schools and universities, and candidates has grown significantly due to various requirements, for example, a candidate should share credentials, for example, education and previous employment history to an organization or a company for hiring process. However, the challenges in data sharing or transferring include, but not limited to, ensuring the security of the data being shared or transmitted and maintaining the data throughout, and supporting of large volumes of data.

Few existing patent references attempted to address the aforementioned problems such as verifying a candidate's credentials such as their education and employment and also manually issuing credentials and/or documents for users are cited in the background as prior art over the presently disclosed subject matter and are explained as follows:

A prior art US20200220726 assigned to Lougheed, III Charles., disclose about systems and methods which provide the ability for users to track the lifecycle and conditional rules associated with credentials. The verifiable data registry is provided with a blockchain, and information can be stored and/or referenced on the verifiable data registry whereas an issuer can define a credential schema. The issuer issues the credential of the holder and stores the credential status of the credential on the verifiable data registry. The credential comprises a digital document that is granted to the holder by the issuer which contains a cryptographic proof, such as a digital signature from the issuer. The issuer sends a credential issuance message back to the holder that contains the verifiable credential whereas the holder can store it in their holder wallet. The holder can individually review and accept the credentials into the holder's wallet. The received digitally signed credentials from primary sources (i.e., issuers) can be securely shared that is with employers, health insurance, etc. A university diploma certificate includes attributes, the university graduation year, GPA, degree, other relevant fields, etc.

Another prior art SG10202000262X assigned to Alishahi Amir Homayoun., disclose about a token server system may also encrypt the document, store the encrypted version document, generate a hash of the document, and create a link to the encrypted version of the document. The token server system may then store the hash and the link on a blockchain using one or more smart contract functions. The token server system may also consume processing tokens and/or a cryptocurrency to perform the blockchain operations. The token server system may publish blockchain links to one or more documents to a blockchain and generate a message corresponding to the link. The message may include the blockchain links and a second icon used to initiate a document generation process. The token server system may use the InterPlanetary File System (IPFS) protocol and/or servers such as Amazon simple storage service (Amazon S3). A law enforcement agency may also use the link for collaboration to share documents with both internal and external stakeholders for a case investigation, or a criminal charge. The link may be a uniform resource locator (URL) or other web address identifying the storage location of the encrypted document. Because the stored document is encrypted, the discovery of the link may still maintain confidentiality due to the encrypted nature of the document. The documents may include certificates such as a birth certificate, marriage certificate, driver's license, college degree, and/or other documents which a user may deem as being official. The preservation on blockchain may indicate that the document is authentic. For example, a university, government agency, and/or other institutions may preserve documents on blockchain related to a user to confirm the authenticity of the document and/or that a particular certificate was issued by the institution.

However, the existing systems and methods do not have any sort of cryptographic proof. The existing systems using a credential schema, thereby limiting the users to upload any type of documents and name those documents according to their preference. Further, the existing systems and methods using a wallet on the blockchain network for sharing documents to the users. The existing systems are using different methods for verifying documents and providing a cryptographic hash for each document on the blockchain. The existing systems may also encrypt the document and store the encrypted version document, generate a hash of the document, and create a link to the encrypted version of the document. Further, the existing systems and methods employ cryptocurrency to perform blockchain operations.

In light of the above-mentioned problems, there is a need for a system to transfer/share credentials via URL link/Hyperlinks/QR codes and securely hosted through IPFS using the blockchain network. There is also a need for a system that enables an issuer to send documents to an end receiver. However, the end receiver of the credential (a credential is any type of document) doesn't need to have a wallet on the blockchain network. The issuer also has the option of just sharing the IPFS hash corresponding to the document with the user either through email or any other medium (QR Code). For example, an issuer can directly send the document internally through our system to the user (into their wallet), or they can send them a link via email with the document's IPFS hash (through URL or QR code) if the receiver is not an internal user of the blockchain. This allows the issuer to share the document both internally through other members of our network or externally with members who are not part of our network. Further, there is also a need for a system to provide a certificate/credential wallet for the users and securely transfer the credentials upon signing up and store the credentials into the user's certificate/credential wallet without using cryptocurrency. The certificate wallet is configured to share the contents of this wallet as individual credentials, part of the credential wallet, or the entire wallet. Further, there is also a need for a system configured to allow users to filter blockchain credentials based on the contents of the wallet. There is also a need for a system for generating an IPFS hash corresponding to each document stored on the blockchain. There is also a need for a system for enabling a user to simply verify documents using the IPFS hash corresponding to each document stored on the blockchain. The user could verify the document using an IPFS document link in the search option and the blockchain transaction history, and then associated with the IPFS hash of that document will show up (who sent the document and who received it, and when the transaction occurred). There is also a need for a system that enables the user to add encrypted files on the blockchain network. The blockchain network does not generate a hash for the document, instead of when the document/certificate is uploaded on the platform it gets uploaded onto the IPFS, and an IPFS hash is generated. This IPFS hash then gets associated with the blockchain transaction hash. The blockchain transaction hash verifies that a particular document with this particular IPFS hash was issued by this particular issuer and sent to that particular receiver.

### SUMMARY OF THE INVENTION

The present invention generally discloses a system for verifying and issuing the education and employment documents of candidates. Further, the present invention discloses a system for verifying education and employment documents of candidates via a blockchain network and creating a blockchain based credentials wallet for the users and/or candidates to securely transfer/share the credentials to universities, human resources, companies, organizations, institutions, and third parties, etc. The system is further configured to automatically sync with existing databases and/or any organizations, institutions, on-premise, cloud, and decentralized databases for retrieving data and using that retrieved data to issue blockchain credentials periodically to the users.

According to the present invention, a system for verifying the education and employment of candidates and creating a blockchain based credentials wallet for the users and/or candidates, according to one embodiment of is disclosed. In one embodiment, the system is configured to enable candidates to store blockchain credentials and verify the candidates' blockchain credentials and create a blockchain based credential wallet for the users and/or candidates to securely transfer/share the credentials. In one embodiment, the system is further configured to enable issuers to check, verify, and also transfer or share diplomas and certificates, test results, and professional accreditation, etc. to the user's blockchain based credential wallet via the network. In one embodiment, the system is further configured to enable receivers to verify the blockchain credentials of a candidate from the blockchain based credential wallet via the network. In one embodiment, the system is further configured to enable the users to share the blockchain credentials and apply universities and jobs using the blockchain credentials stored in the blockchain based credential wallet and also enables the candidates to share the blockchain credentials with one or more third parties through a quick response (QR) code/URL link/HyperLink. The blockchain based credential wallet is configured to enable the users or candidates to store the user's blockchain credentials. In one embodiment, the issuers are at least any one or a combination of, but not limited to, schools, colleges, universities, institutions, general employers, and training and coaching institutions, etc. In one embodiment, the receivers at least any one or a combination of, but not limited to, universities, human resources, companies, organizations, institutions, and third parties, etc.

In one embodiment, the system comprises a computing device having a processor and a memory having a software module executed by the processor. In one embodiment, the software module could be at least one of, but not limited to, a plug-in component and/or a browser extension and/or a webpage application (web app), and/or docker containers run on virtual machines. In one embodiment, the processor is in communication with a server via a network and configured to execute a set of instructions stored in the memory. In one embodiment, a database in communication with the server is configured to store data related to users and/or candidates' profiles, wherein the database comprises one or more program modules, which are executed by the processor to perform multiple functions.

In one embodiment, the computing device is at least any one of, but not limited to, a smartphone, a laptop, a computer, a tablet, a mobile phone, or other suitable mobile and/or electronic devices and also virtual machines on cloud servers. In one embodiment, the network could be, but not limited to, a blockchain network, a private blockchain network based on Hyperledger and its frameworks such as, but not limited to, Fabric, Sawtooth, Indy, Burrow, chaincode and smart contracts, and an Ethereum network. In one embodiment, the system could be a platform or a browser extension, which is installed in the computing device, which is wired or wirelessly connected to the network, for example, a blockchain network. In one embodiment, the browser extension could be stored in an internal or external database, which in communication with the server. In one embodiment, the computing device is enabled to access the server via the network. In one embodiment, the computing device is in communication with the server, wherein such communication is established via a software application, a browser extension, a mobile application, a browser, an OS, and/or any combination thereof.

In one embodiment, the server could be operated as a single computer and/or multiple load balanced virtual machines on the cloud or cluster of load balanced virtual machines on the cloud. In some embodiments, the computing device could be, but not limited to, a touch screen and/or a non-touchscreen and adapted to run on any type of OS, such as iOS™, Windows™, Android™, Unix™, Linux™ and/or others. In one embodiment, the server could be a cloud server. In one embodiment, the platform of the system could be built on a programmable Blockchain network, for example, a private blockchain network based on Hyperledger and its frameworks such as, but not limited to, Fabric, Sawtooth, Indy, Burrow, chaincode, and smart contracts, and Ethereum and allows the users and/or individuals or candidates to securely transfer or share credentials stored in a blockchain based credential wallet via the blockchain network to one or more electronic devices or user devices, for example, a smartphone.

In one embodiment, the blockchain network is designed to issue and send credentials between users. In one embodiment, the system is configured to enable the users to securely transfer/share the stored credentials with each other using a user device. In one embodiment, the user device is in communication with the server via the blockchain network. In one embodiment, the system is configured to enable an issuer of these blockchain credentials to be able to issue a credential that could be claimed through, but not limited to, an internal blockchain transfer, transfer via the IPFS hash, a QR code, and/or URL/Hyperlink. In one embodiment, the blockchain based credentials could be quickly issued, transferred, and shared even with users outside of the system. In one embodiment, the credentials themselves are issued and recorded on the blockchain. In one embodiment, the database could be an InterPlanetary file system, which is a protocol and peer-to-peer network for storing and sharing the candidate's blockchain credentials in a distributed file system. In one embodiment, the InterPlanetary file system (IPFS) is a way to securely host those credentials. In one embodiment, a QR code and URL/HyperLink is a way to share/transfer the credentials.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a system for verifying education and employment of candidates and creating a blockchain based credentials wallet for the users and/or candidates, according to an embodiment of the present invention.

FIG. 2 shows a flowchart of a method to filter blockchain credentials based on the contents of the blockchain based credential wallet and also outlining the process flow for issuers to generate certain credentials, store the credentials on a user wallet, and then could share with receivers in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

In modern coding, one solution is to use the coding language JavaScript to accomplish this. Modern web browsers are all built to read the coding languages CSS, HTML, and JavaScript. JavaScript is responsible for web page actions and can change the text on buttons, click buttons, add data to fields, and perform actions that otherwise would need a human to execute. Google Chrome browser for example allows developers to create browser extensions that, using JavaScript or a combination of CSS, HTML, and JavaScript, will change or update web pages based on user needs with minimal or no user intervention.

Embodiments of the present invention include, but are not limited to the following detailed description of drawings. The included drawings show examples of the invention as, but not limited to, a webpage application (web app), docker containers run on virtual machines, and/or a browser extension created, designed, and/or coded to interact with the web forums of online sites, to copy data that has been previously entered and is now displayed on one web page or web form and paste this data into the appropriate fields of another website's online forum, where data can include, but not be limited to, text, HTML markup or tags, images, videos, graphics, other types of files, and any other relevant data type as could be found online or entered into an online form.

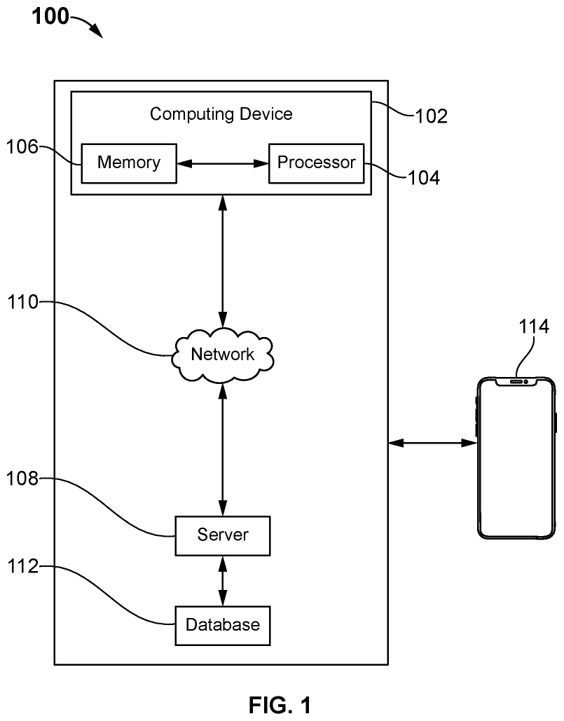

Referring to FIG. 1, a block diagram of a system 100 for verifying education and employment of candidates and creating a blockchain based credentials wallet for the users and/or candidates, according to one embodiment of the present invention. In one embodiment, the system 100 is configured to verifying the education and employment of candidates. In one embodiment, the system 100 is further configured to create a blockchain based credentials wallet for the users and/or candidates to securely transfer/share the credentials. The blockchain based credential wallet is configured to enable the users or candidates to store the user's blockchain credentials. In one embodiment, the system 100 is further configured to enable the users or candidates to apply for jobs and universities using blockchain credentials in the blockchain based credential wallet.

In one embodiment, the system 100 comprises a computing device 102 having a processor 104 and a memory 106 having a software module executed by the processor 104. In one embodiment, the software module could be a webpage application (web app), and/or docker containers run on virtual machines. In some embodiments, the software module could be at least one of, but not limited to, a plug-in component and/or a browser extension. In one embodiment, the processor 104 is in communication with a server 108 via a network 110 and configured to execute a set of instructions stored in the memory 106. In one embodiment, a database 112 in communication with the server 108 is configured to store data related to users and/or candidates' profiles. The database 112 comprises one or more program modules, which are executed by the processor 104 to perform multiple functions.

In one embodiment, the computing device 102 is at least any one of, but not limited to, a smartphone, a laptop, a computer, a tablet, a mobile phone, or other suitable mobile and/or electronic devices, and also and also virtual machines on cloud servers. In one embodiment, the network 110 could be, but not limited to, a blockchain network, a private blockchain network based on Hyperledger and its frameworks such as, but not limited to, Fabric, Sawtooth, Indy, Burrow, chaincode and smart contracts, and an Ethereum network. In one embodiment, the system 100 could be a platform or a browser extension, which is installed in the computing device 102, which is wired or wirelessly connected to the network 110, for example, a blockchain network. In one embodiment, the browser extension could be stored in an internal or external database 112, which in communication with the server 108. In one embodiment, the computing device 102 is enabled to access the server 108 via the network 110. In one embodiment, the computing device 102 is in communication with the server 108, wherein such communication is established via a software application, a browser extension, a mobile application, a browser, an OS, and/or any combination thereof.

In one embodiment, the server 108 could be operated as a single computer and/or multiple load-balanced virtual machines on the cloud or cluster of load-balanced virtual machines on the cloud. In some embodiments, the computing device 102 could be, but not limited to, a touch screen and/or a non-touchscreen and adapted to run on any type of OS, such as iOS™, Windows™, Android™, Unix™, Linux™ and/or others. In one embodiment, the server 108 could be a cloud server. In one embodiment, the platform of the system 100 could be built on a programmable Blockchain network, for example, a private blockchain network based on Hyperledger and its frameworks such as but not limited to, Fabric, Sawtooth, Indy, Burrow chaincode, and smart contracts, Ethereum and allows the users and/or individuals or candidates to securely transfer or share credentials stored in a blockchain based credential wallet via the blockchain network to one or more electronic devices or user devices 114, for example, a smartphone. In one embodiment, the user device 114 is in communication with the server 108 via the blockchain network.

In one embodiment, the blockchain network is designed to issue and send credentials between users. In one embodiment, the system 100 is configured to enable the users to securely transfer/share the stored credentials with each other. In one embodiment, the system 100 is configured to enable an issuer of these blockchain credentials to be able to issue a credential that could be claimed through, but not limited to, Blockchain, IPFS, a QR code, and/or URL/Hyperlink. In one embodiment, the blockchain based credentials could be quickly issued, transferred, and shared even with users outside of the system 100. In one embodiment, the credentials themselves are issued and recorded on the blockchain. In one embodiment, the database 112 could be an InterPlanetary file system, which is a protocol and peer-to-peer network for storing and sharing the candidate's blockchain credentials in a distributed file system. In one embodiment, the InterPlanetary file system (IPFS) is a way to securely host those credentials. In one embodiment, a QR code and URL/HyperLink is a way to share/transfer the credentials.

In an exemplary embodiment, if an employer wants to provide a credential to one of their employees then they could send an email with a link in it. Upon clicking that link the employee would be asked to either signup or login into their account. Upon signing up or logging in, the credential is transferred into the employee's credential wallet. In one embodiment, the system 100 is configured to enable an issuer to send documents to an end receiver. However, the end receiver of the credential (a credential is any type of document) doesn't need to have a wallet on the blockchain network. The issuer also has the option of just sharing the IPFS hash corresponding to the document with the user either through an email or any other medium, for example, a URL link/Hyperlink/QR code. In an exemplary embodiment, an issuer could directly send the document internally through the system 100 to the user (into their wallet), or they could send them a link via email with the document's IPFS hash through the URL link or QR code if the receiver is not an internal user of the blockchain.

In an exemplary embodiment, a user could issue a blockchain credentials through a URL link/Hyperlink/QR code. Upon issuing it they could share/transfer to the appropriate person. So, they could create a URL link/Hyperlink/QR code and share it with the recipient. Upon receiving the URL link/Hyperlink/QR code, the recipient could claim those blockchain credentials by clicking on the URL link/Hyperlink or by scanning the QR code. By doing this they will be prompted to login or sign up for an account and the credential will be deposited into their credential wallet. This is different from sending cryptocurrencies through the QR code because the QR code has no information about the recipient's public wallet key. In one embodiment, the sender does not need to know the public wallet key of the recipient or even know that the recipient has a wallet or not. This allows the sender could share the document both internally through other members of the blockchain network or externally with members who are not part of the blockchain network. The QR code does not initiate a transaction and rather it is a medium to locate the document on the blockchain. At that point, the user could view, share, or claim the document.

In one embodiment, there is also a difference in viewing blockchain documents via the QR code/Hyperlinks/URL links. The difference is that viewing credentials via these mediums is nothing proprietary. Rather, the system 100 could transfer these credentials using these mediums. In one embodiment, the credential could not send until the recipient either open or scans the Hyperlink/URL link/QR code and either sign up or signs into the system 100. Upon recognizing that the recipient has an account and by virtue of a blockchain wallet associated with that account (all accounts on the network have wallets associated with them) the credential is sent to that wallet's address.

In one embodiment, the system 100 is further configured to generate an IPFS hash corresponding to each document stored on the blockchain. The system 100 enables the user to simply verify documents using the IPFS hash corresponding to each document stored on the blockchain. In one embodiment, the user could verify the document using an IPFS document link in the search option and the blockchain transaction history, and then associated with the IPFS hash of that document will show up (who sent the document and who received and when the transaction occurred). In one embodiment, the system 100 is further configured to enable the user to add encrypted files on the blockchain network. The blockchain network does not generate a hash for the document, instead of when the document/certificate is uploaded on the platform it gets uploaded onto the IPFS and an IPFS hash is generated. This IPFS hash then gets associated with the blockchain transaction hash. The blockchain transaction hash verifies that a particular document with this particular IPFS hash was issued by this particular issuer and sent to that particular receiver.

In one embodiment, the computer-implemented credentials verification network utilizes blockchain technology and tracks/verifies the credentials for candidates that could later be used in the hiring verification process. In one embodiment, a company has a change in employment for a particular employee that company can publish and update of the employee's employment information onto the blockchain, wherein the information can be shared among the peer nodes connected to the blockchain network. Each entity utilizing the verification network can be equipped with the functionality to publish onto the blockchain network.

In one embodiment, an applicant graduate from university seeking a job received a notification that her/his university certificate is verified on the verification network to manage her/his verified records, he/she registers and creates a profile on the network. After the profile is created and his/her identity could be verified, a graduation certificate could be stored in his/her digital profile on the verification network. In one embodiment, the network comprises a permissioned blockchain, which could be used to track employee profiles on the network. Permissioned blockchains are also different from private blockchains, which allow only known nodes to participate in the network. The permissioned blockchains may allow anyone to join a network once their identity and role are defined. The permissioned blockchains could maintain the identity of each blockchain participant on the network.

In one embodiment, the system 100 is further configured to sync with existing databases for retrieving data and using that retrieved data to issue credentials periodically to students or employees. In an exemplary embodiment, at the end of every school term, the system 100 could automatically access the school's database and retrieve the entire student's mark data for that term and issue it directly to the students without the students needing to file a request.

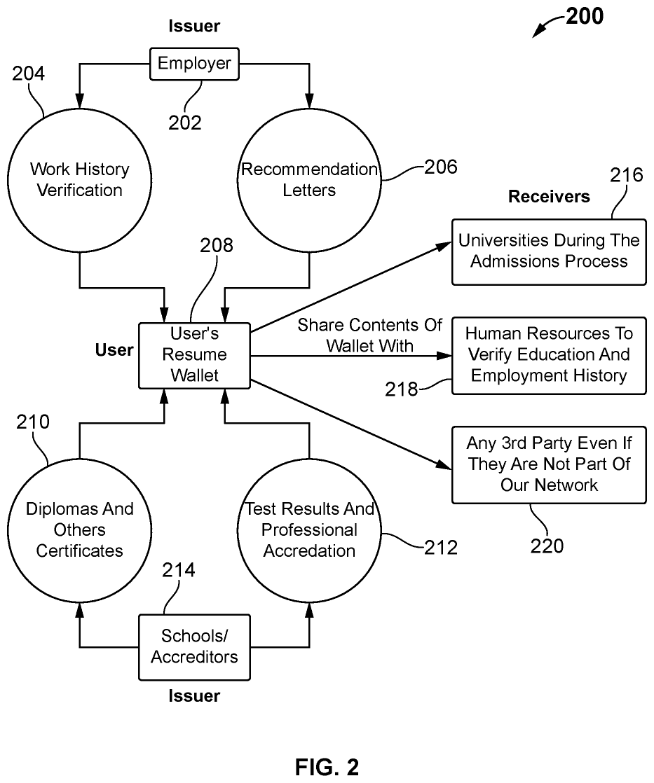

Referring to FIG. 2, a flowchart 200 of a method to filter blockchain credentials based on the contents of the blockchain based credential wallet in an exemplary embodiment of the present invention is disclosed. At steps 202, 204, and 206, an employer could verify the blockchain credentials such as work history and recommendation letters of a candidate from the user's resume wallet 208 via the blockchain network. In one embodiment, the employer could be an issuer. At steps 210, 212, and 214, the schools/accreditors could check, verify, and also transfer or share the diplomas and other certificates and also test results and professional accreditation to the user's resume wallet 208. In one embodiment, the schools/accreditors could be an issuer. At step 216, the user or candidate could directly and securely share the content stored in the user's resume wallet 208 to one or more universities during the admissions process using the user device 114. At step 218, the user or candidate could directly and securely share the content stored in the user's resume wallet 208 to human resources for verifying education and employment history. At step 220, the user or candidate could directly and securely share the content stored in the user's resume wallet 208 to any third party even if they are not part of the network. In one embodiment, the universities, human resources, and a third party could be receivers. In one embodiment, the user requests individual documents and credentials from different sources, and all these documents and credentials are then stored on the blockchain based credential wallet. Further, the system 100 could enable the user or candidate to share this blockchain based credential wallet to one or more universities, employers, human resources, and third parties, etc. In one embodiment, the blockchain based credential wallet could be acted as a resume because it includes the user's education, work experience, credentials, accomplishments, etc.

In one embodiment, employers could issue work experience credentials to users on the blockchain network and also users not on the blockchain network and users could request documents and credentials from the employer. In one embodiment, universities could issue educational credentials such as diplomas, certifications and/or degrees, etc. to users on the blockchain network and also not on the blockchain network. In one embodiment, the users could request documents and credentials from the university. In one embodiment, all credentials issued to a user are stored in the user's “Wallet” (resume) 208. In one embodiment, the contents of this wallet can be shared with universities and employers. If the user chooses to keep their wallet public, employers can search and sort users based on their credentials and qualifications in the “Wallet” (resume) 208. Employers could contact users for job openings and users can apply to jobs posted by employers, upon which the contents of their “wallet” (which they choose to make public) will be shared with the employer. In one embodiment, the users could also apply to university programs, upon which the contents of their “wallet” (which they choose to make public) will be shared with the university. In one embodiment, the users could connect and view with other users and view their public “wallet”. In one embodiment, wallets or individual credentials could also be shared with the parties outside of the network using a URL link or QR code.

In one embodiment, a credentials verification process includes the following steps. At one step, the candidate's resume could be passed to a team for interviews and ask the candidate to reach out to the unverified company for a certificate. Further, the candidate can then contact his previous employer and get them to issue a certificate on the network and resubmit his fully verified resume. In one embodiment, the resume/recruitment is secured using, but not limited to, Blockchain and Quick Response (QR) Code verification. In one embodiment, the QR code is embedded on the resume with a unique digital hash inside the QR code. The hash holds information that is then placed on the blockchain network for security and authentication.

In one embodiment, the certificates with the QR code or unique serial number could be provided and stored in the blockchain, wherein the E-certificates can be used by the student for applying for jobs. In one embodiment, students need to register and login, and apply for a certificate by filling in the required details. After verifying the information, E-certificate with a QR code or serial number is generated and sent to the student which could be used by the students for applying jobs. In one embodiment, the E-certificate with QR code or serial number could be auto-generated.

In one embodiment, the system is further configured to automatically sync with existing databases and/or any organizations, institutions, on-premise, cloud, and decentralized databases for retrieving data and using that retrieved data to issue blockchain credentials periodically to the users. In one embodiment, the system is further configured to interface with an in-built and custom application programming interface (API) that will be seamlessly integrated with the HR management systems.

In one embodiment, the system directly integrates into the HR management system (software) or any other databases (student databases for education, legal databases for legal information) and retrieves or pulls data from these databases using API calls. The data is automatically pulled on a periodic basis and based on the data blockchain based credentials are issued. In an exemplary embodiment, the system could retrieve the employment data from the HR management software and then automatically issue an employment verification document to all the employees every month. The document issuance could also be periodic. The document issuance could be one time. Let's say at the end of the work term, the leaving employee will automatically receive a document verifying their work history that they could share with their new employer.

In one embodiment, the system could also enable the user to share or transfer and/or issue credentials/documents related to medical information in a secure manner through the blockchain. In an exemplary embodiment, a health provider or a hospital respectively could upload their patients' medical records or vaccination records and issues it directly to their patients through the blockchain. The patients could access the verifiable records issued by the health provider or hospital. If they get hospitalized far from home, they have access to their data and have better control of whom they share their information with. There are many other use cases such as vaccination passports, vaccination records for schools, and prescription records, which could be verified through the blockchain. In one embodiment, the system could also enable the user to share or transfer and/or issue and validate credentials/documents related to the legal information in a secure manner through the blockchain network, thereby speed up the verification process. Thus, preventing others from forging and making fake legal documents.

The advantages of the present invention include but are not limited to, the system 100 is faster as it does not require the printing and mailing of hardcopy transcripts. The system 100 also simplifies employment verification. The employer could verify the employment history on the user's blockchain based credential wallet during the job application process on the blockchain. The system 100 is cheaper for users and employers, as users do not need to request multiple transcripts from their educational institutions. Employers do not need to spend hundreds if not thousands of dollars on the employment verification. The system 100 is transparent as the user knows exactly what part of their professional history is being shared with others. Furthermore, it prevents redundancies. For example, if the candidate applies for a job, they will conduct education verification. If the candidate applies to another job after a year down the line, they will again conduct education verification. In the future, the employers could simply access the information by having an education history on the blockchain based credential wallet. Thus, saving the employer time and effort in contacting the universities and employers, etc. In one embodiment, the system 100 could be used for education/employment verification, university applications, job applications, professional social networking, sharing accomplishments on social media, etc.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for verifying credentials of a candidate, comprising:
a computing device having a memory and a processor, wherein the computing device is in communication with a server via a network and one or more user devices;
wherein the memory having a software module executed by the processor,
wherein the software module is at least one of a webpage application (web app), docker containers run on virtual machines, a plug-in component, and/or a browser extension, wherein the processor is in communication with a server via a network;
a database in communication with the server or a distributed network configured to store data related users, wherein the database comprising one or more program modules, which are configured to:
enable candidates to store blockchain credentials and verify the candidates' blockchain credentials using a user device,
wherein the user device is in communication with the server via the network;
create at least one blockchain based credential wallet for the users and/or candidates to securely transfer/share credentials;
enable issuers to check, verify, and also transfer or share professional and educational credentials and/or blockchain credentials to the user's blockchain based credential wallet via the network;
enable receivers to verify the professional and educational credentials and/or blockchain credentials of a candidate from the blockchain based credential wallet via the network,
wherein the receivers enter a generated IPFS hash corresponding to that particular document stored on the blockchain ledger into a search option thus the receivers verify the professional and educational credentials and/or blockchain credentials of the candidate on the blockchain network,
wherein the system is configured to generate an IPFS hash corresponding to each document when it is uploaded on the blockchain;
enable the users to share or transfer the blockchain credentials and apply universities and jobs using the blockchain credentials stored in the blockchain based credential wallet.

2. The system of claim 1, wherein the computing device is in communication with the server, wherein such communication is established via the network.

3. The system of claim 1, wherein the network is a blockchain network, a private blockchain network based on Hyperledger and its frameworks such as Fabric, Sawtooth, Indy, Burrow, chaincode, and smart contracts.

4. The system of claim 1, is further configured to enable the candidate to share or transfer the blockchain credentials to one or more third parties through a quick response (QR) code.

5. The system of claim 1, is further configured to enable the candidate to share or transfer the blockchain credentials to one or more third parties through at least any one of a uniform resource locator (URL) link, a hyperlink, and/or a web address.

6. The system of claim 1, wherein the browser extension is designed and coded using at least any one or a combination of blockchain technology, JavaScript, a cascading style sheets (CSS), hypertext markup language (HTML) and any combination thereof to interact with the web forms of websites.

7. The system of claim 1, wherein the blockchain network is designed and coded using at least any one or a combination of technologies includes chaincode, smart contracts, Go, node js, java, Hyperledger, and Ethereum.

8. The system of claim 1, wherein the computing device and user device are at least any one of a smartphone, a laptop, a computer, a tablet, a mobile phone, or other suitable mobile and/or handheld electronic devices, virtual machines on cloud servers, and docker containers.

9. The system of claim 1, wherein the issuers are at least any one or a combination of schools, colleges, universities, institutions, any type of employer, and training and coaching institutions.

10. The system of claim 1, wherein the receivers are at least any one or a combination of universities, human resources, companies, organizations, institutions, schools, employers, and third parties.

11. The system of claim 1, wherein the database is an InterPlanetary file system, which is a protocol and peer-to-peer network for storing and sharing the candidate's blockchain credentials in a distributed file system.

12. The system of claim 1, is further configured to automatically sync with existing databases and/or any organizations, institutions, on-premise, cloud, and decentralized databases for retrieving data and using that retrieved data to issue blockchain credentials periodically to the users.

13. The system of claim 1, is further configured to interface with an in-built and custom application programming interface (API) that will be seamlessly integrated with the HR management systems.

14. A system for issuing verified credentials of a candidate using blockchain technology, comprising:
a computing device having a memory and a processor, wherein the computing device is in communication with a server via a network and one or more user devices;
wherein the memory having a software module executed by the processor,
wherein the software module is at least one of a webpage application (web app), docker containers run on virtual machines, a plug-in component, and/or a browser extension, wherein the processor is in communication with a server via a blockchain network;
an InterPlanetary file system in communication with the server configured to store data related users, wherein the InterPlanetary file system comprising one or more program modules, which are configured to:
enable candidates to store blockchain credentials using a user device and verify the candidates' blockchain credentials, wherein the user device is in communication with the server via the blockchain network;
create at least one blockchain based credential wallet for the users and/or candidates to securely transfer/share credentials as well as to issue blockchain credentials for the users and/or candidates;
enable issuers to check, verify, and also transfer or share professional and educational credentials and/or blockchain credentials to the user's blockchain based credential wallet via the network;
enable receivers to verify the professional and educational credentials and/or blockchain credentials of a candidate from the blockchain based credential wallet via the network, wherein the receivers enter a generated IPFS hash corresponding to that particular document stored on the blockchain ledger into a search bar thus the receivers verify the professional and educational credentials and/or blockchain credentials of the candidate on the blockchain network,
wherein the system is configured to generate an IPFS hash corresponding to each credential/document when it is uploaded on the blockchain and also generate a document transaction history page that consists of a transaction flow and a preview of the actual blockchain credentials/document being verified;
enable the users to share or transfer and/or issue the blockchain credentials and apply universities and jobs using the blockchain credentials stored in the blockchain based credential wallet, and
enable the candidate to share or transfer and/or issue the professional and educational credentials and/or blockchain credentials to one or more third parties through a quick response (QR) code.

15. The system of claim 14, wherein the computing device is in communication with the server, wherein such communication is established via the blockchain network.

16. The system of claim 14, is further configured to enable the candidate to share or transfer the professional and educational credentials and/or blockchain credentials to one or more third parties through at least any one of a uniform resource locator (URL) link, a hyperlink, and/or a web address.

17. The system of claim 14, wherein the browser extension is designed and coded using at least any one or a combination of blockchain technology, JavaScript, a cascading style sheets (CSS), hypertext markup language (HTML) and any combination thereof to interact with the web forms of websites.

18. The system of claim 14, wherein the blockchain network is designed and coded using at least any one or a combination of technologies include chain code, smart contracts, Go, node js, java, Hyperledger, and Ethereum.

19. The system of claim 14, wherein the computing device and user device are at least any one of a smartphone, a laptop, a computer, a tablet, a mobile phone, or other suitable mobile and/or handheld electronic devices, virtual machines on cloud servers, and docker containers.

20. The system of claim 14, wherein the issuers are at least any one or a combination of schools, colleges, universities, institutions, employers, and training and coaching institutions.

21. The system of claim 14, wherein the receivers are at least any one or a combination of universities, human resources, companies, organizations, institutions, schools, employers, and third parties.

22. The system of claim 14, wherein the blockchain network is a private blockchain network based on Hyperledger and its frameworks such as Fabric, Sawtooth, Indy, Burrow, chaincode and smart contracts, and an Ethereum.

23. The system of claim 14, is further configured to automatically sync with existing databases and/or any organizations, institutions, on-premise, cloud, and decentralized databases for retrieving data and using that retrieved data to issue blockchain credentials periodically to the users.

24. The system of claim 14, is further configured to interface with an in-built and custom application programming interface (API) that will be seamlessly integrated with the HR management systems.
